(19) United States
(12) Patent Application Publication
(10) Pub. No.: US 2026/0098592 A1
(43) Pub. Date: Apr. 9, 2026

(54) MODULAR VALVE ACTUATOR

(71) Applicant: ITT Manufacturing Enterprises LLC, Wilimington, DE (US)

(72) Inventor: Caleb Whitt, Westminster, SC (US)

(21) Appl. No.: 19/354,092

(22) Filed: Oct. 9, 2025

Related U.S. Application Data
(60) Provisional application No. 63/705,208, filed on Oct. 9, 2024.

(51) Int. Cl. F16K 31/54; F16K 31/60

(52) U.S. Cl. CPC F16K 31/54; F16K 31/60

(57) ABSTRACT

A modular valve actuator includes a housing, a pinion defining an opening and including pinion teeth, a rack including rack teeth and a position target, and a sensor. The pinion teeth interlock and interact with the rack teeth. The modular valve actuator is configured to be installed directly to a valve by guiding the modular valve actuator over a valve stem wherein the valve stem is bounded within a pinion of the modular valve actuator, and the sensor is a non-contact sensor which detects the position target in the rack and generates position data related to an open or closed position of the valve.

### CROSS-REFERENCE TO RELATED APPLICATIONS

This application claims the benefit of and priority to U. S. Provisional Patent Application No. 63/705,208 filed on Oct. 9, 2024, the entire contents of which are incorporated by reference herein.

### TECHNICAL FIELD

The present disclosure generally relates to an actuator for opening and closing of a valve.

### BACKGROUND

Unless otherwise indicated herein, the materials described in this section are not prior art to the claims herein and are not admitted as being prior art by inclusion in this section.

Valves may be used in industries such as oil and gas. A valve may control a flow of a fluid through a body of the valve. An actuator may be a mechanical device with a power source which may control movement of the diaphragm of the diaphragm valve. The actuator may control the diaphragm of a diaphragm valve to open and close a fluid flow path through the body of the diaphragm valve or may allow an intermediate position of the diaphragm. The actuator may be electric, pneumatic, or hydraulic powered.

### SUMMARY

Existing challenges associated with cable connector grip systems, as well as other challenges, are overcome by the presently disclosed cable connector grip system. One embodiment of the present disclosure is a modular valve actuator. The modular valve actuator includes a housing, a pinion defining an opening and including pinion teeth, a rack including rack teeth and a position target, and a sensor. The pinion teeth interlock and interact with the rack teeth. The modular valve actuator is configured to be installed directly to a valve by guiding the modular valve actuator over a valve stem wherein the valve stem is bounded within a pinion of the modular valve actuator and the sensor is a non-contact sensor which detects the position target in the rack and generates position data related to an open or closed position of the valve.

In aspects, the position target is a magnet.

In aspects, the sensor is attached to the housing.

In aspects, the modular valve actuator further includes a connector, and the sensor sends the position data to the connector.

In aspects, the connector provides the positional data to a device attached to the connector.

In aspects, the pinion and rack are constructed from metal.

In aspects, the pinion and rack are constructed from one of stainless steel, bronze or aluminum.

In aspects, the rack is positioned between a first piston and a second piston with the first piston on a right side of the rack and the second piston on a left side of the rack.

In aspects, first and second pistons are floating pistons.

In aspects, modular valve actuator further includes a stem extension configured to be attached to the valve stem.

In aspects, modular valve actuator further includes a handle spacer configured to be installed over the stem extension.

In aspects, modular valve actuator further includes a handle configured to be attached to the stem extension to provide manual override capability to the valve.

Another embodiment of the present disclosure includes a method of attaching a modular valve actuator to a valve. The method includes removing a handle of the valve from a valve stem. The method includes guiding the modular valve actuator over the valve stem wherein the valve stem is bounded within a pinion of the modular valve actuator. The method includes securing the modular valve actuator to the valve with bolts.

In aspects the method further includes attaching a stem extension to the valve stem.

In aspects the method further includes installing a handle spacer over the stem extension.

In aspects the method further includes attaching a handle to the stem extension.

In aspects the method further includes a sensor of the modular valve actuator detecting a target and generating positional data related to an open or closed position of the valve.

In aspects the method further includes transmitting, by the sensor, the positional data to a connector of the modular valve actuator.

In aspects the method further includes providing, by the connector, the positional data to a device attached to the connector.

Another embodiment of the present disclosure includes a modular valve actuator including a housing, a pinion constructed from metal, a rack constructed from metal, a first piston on a right side of the rack, a second piston on a left side of the rack, and a sensor. The pinion defines an opening and includes pinion teeth. The rack includes rack teeth and a position target. The pinion teeth interlock and interact with the rack teeth. The position target is a magnet. The modular valve actuator is configured to be installed directly to a valve by guiding the modular valve actuator over a valve stem of the valve, wherein the valve stem is bounded within the opening defined by the pinion of the modular valve actuator. The sensor is a non-contact sensor which detects the position target in the rack and generates positional data related to an open or closed position of the valve.

The foregoing summary is illustrative only and is not intended to be in any way limiting. In addition to the illustrative aspects, embodiments, and features described above and below, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a top perspective view of a modular valve actuator in accordance with the present disclosure;

FIG. 2 is a side perspective view of a modular valve actuator and a valve in accordance with the present disclosure; and

FIG. 3 is a top perspective view of a modular valve actuator attached to a valve in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

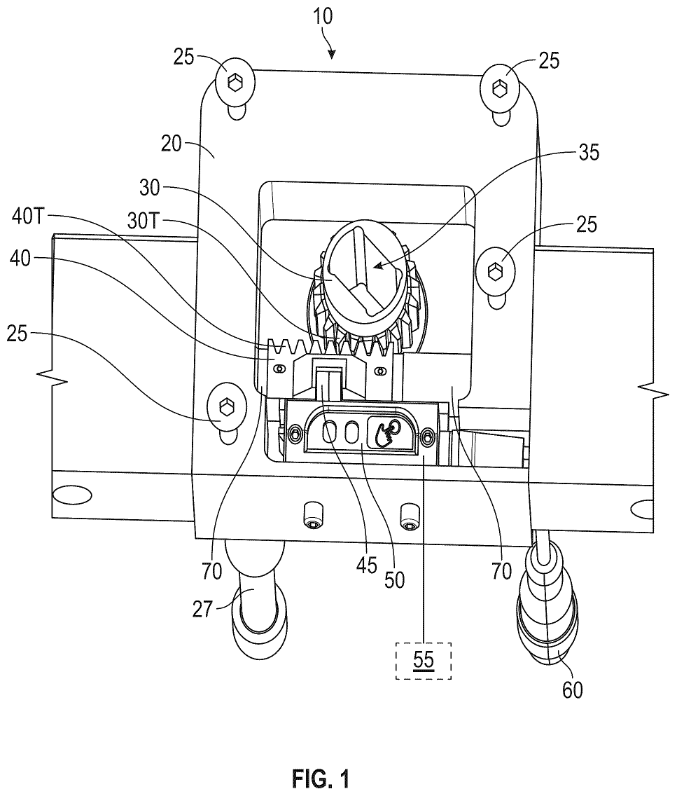

FIG. 1 is a top perspective view of a modular valve actuator in accordance with at least some embodiments described herein. Modular valve actuator 10 may include a housing 20, bolts 25, spacers 27, a pinion 30, a rack 40, a sensor 50, a connector and pistons 70. Housing 20 may be made from metal including aluminum or steel. Pinion 30 may define an opening 35 through pinion 30 which may be configured to surround and secure a stem of a valve. Modular valve actuator 10 may be configured to be installed directly to a valve by removing a handle of the valve and guiding modular valve actuator 10 over the stem of the valve so that the stem of the valve is bounded within opening 35 defined by pinion 30. Bolts 25 and spacers 27 may attach housing 20 to the valve when bolts 25 are secured to the valve.

Pinion 30 may rotate when the stem of the valve secured within opening 35 rotates as the valve opens and closes. Pinion 30 may include teeth 30T along an outer edge of pinion 30. Rack 40 may include teeth 40T along a front side of rack 40. Pinion 30 and rack 40 may be constructed from metal including stainless steel, bronze or aluminum. Teeth 30T of pinion 30 may interlock and interact with teeth 40T of rack 40. Rack 40 may be positioned between pistons 70 with one piston 70 in contact with rack 40 on a right side of rack 40 and one piston 70 in contact with rack 40 on a left side of rack 40. Pistons 70 may be floating pistons and may keep teeth 40T of rack 40 aligned with teeth 30T of pinion 30 as pinion 30 rotates and rack 40 translates in response. Rack 40 may translate right or left based on a direction pinion 30 rotates. Rack 40 may further include magnets 45 which may function as a target for sensor 50.

Sensor 50 may be a position sensor and may be a non-contact sensor such as, but not limited to, a magnetic sensor. Other types of non-contact sensors such as a Hall effect sensor, an inductive sensor, or a resistive sensor, may also be contemplated. Sensor 50 may be attached to housing 20 and may be stationery within housing 20. Sensor 50 may detect a position of target magnets 45 within rack 40 and may generate positional data 55 based on movement of rack 40. Positional data 55 may be data related to a position of rack 40 and target magnets 45 as detected by sensor module 50. Sensor 50 may transmit position data 55 to connector 60. Connector 60 may be an external connector of modular valve actuator 10 and may be configured to provide positional data 55 to a device attached to connector 60. Connector 60 may be configured to connect to any device capable of receiving positional data 55 including a mobile device, data storage device, processor, or a device configured to transmit positional data 55. Positional date 55 may be utilized for determining an open or closed position of the valve.

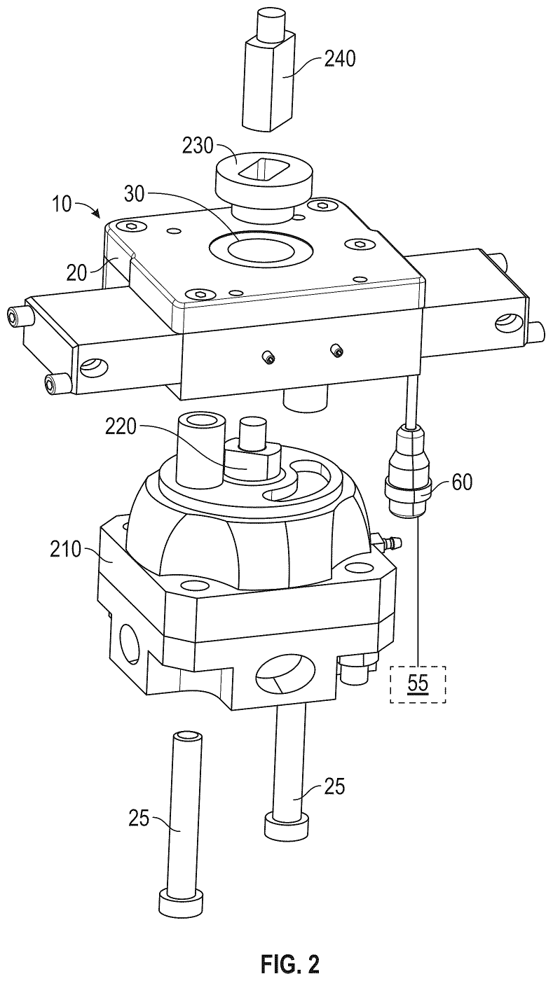

FIG. 2 is a side perspective view of a modular valve actuator and a valve in accordance with at least some embodiments described herein. Those components in FIG. 2 that are labeled identically to components of FIG. 1 will not be described again for the purposes of brevity.

As previously described, modular valve actuator 10 may be configured to be installed directly to a valve 210 by guiding modular valve actuator opening 35 of pinion 30, over a stem 220 of valve 210 and bounding stem 220 within pinion 30. Modular valve actuator may further include a stem extension 240 which may be configured to be attached to valve stem 220 and aligned when inserted into opening 35 of pinion 30. When modular valve actuator 10 is attached to valve 210, a handle spacer 230 configured to be installed over stem extension 240 may be installed. Handle spacer 230 may be configured to allow a handle to be attached to stem extension 240 of modular valve actuator 10 to provide manual override capability to valve 210.

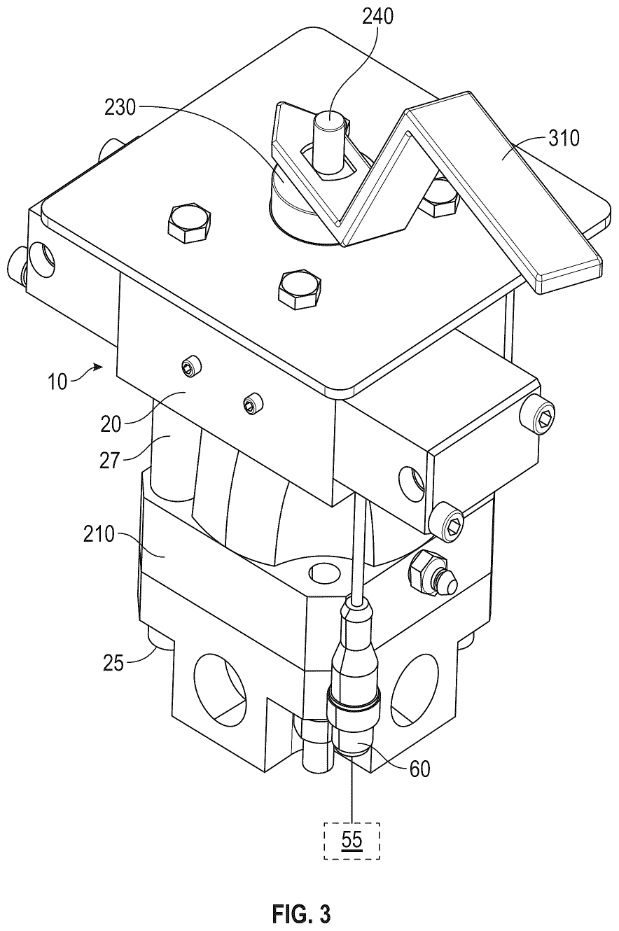

FIG. 3 is a top perspective view of a modular valve actuator attached to a valve in accordance with at least some embodiments described herein. Those components in FIG. 3 that are labeled identically to components of FIG. 1-2 will not be described again for the purposes of brevity.

As shown in FIG. 2, modular valve actuator 10 may be installed directly to a valve 210 by guiding modular valve actuator opening 35 of pinion 30, over stem 220 of valve 210 and bounding stem 220 within pinion 30. A handle 310 may be configured to be attached to stem extension 240 of modular valve actuator 10 and may be in contact with handle spacer 230 to provide manual override capability to valve 210.

A device in accordance with the present disclosure may provide a modular valve actuator which can be installed on various valves and provide both an actuator for opening and closing the valve and also provide positional data about an open/close position of the valve. A device in accordance with the present disclosure may provide a modular valve actuator which can provide both an actuator for opening and closing the valve and also receive a handle to provide manual override capability to valve.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A modular valve actuator comprising:
a housing;
a pinion defining an opening and including pinion teeth;
a rack including rack teeth and a position target, wherein the pinion teeth interlock and interact with the rack teeth; and
a sensor, wherein the modular valve actuator is configured to be installed directly to a valve by guiding the modular valve actuator over a valve stem of the valve, wherein the valve stem is bounded within the opening defined by the pinion of the modular valve actuator, and the sensor is a non-contact sensor which detects the position target in the rack and generates positional data related to an open or closed position of the valve.

2. The modular valve actuator of claim 1, wherein the position target is a magnet.

3. The modular valve actuator of claim 1, wherein the sensor is attached to the housing.

4. The modular valve actuator of claim 1, further comprising a connector and the sensor is configured to send the position data to the connector.

5. The modular valve actuator of claim 4, wherein connector is configured to provide the positional data to a device attached to the connector.

6. The modular valve actuator of claim 1 wherein the pinion and rack are constructed from metal.

7. The modular valve actuator of claim 6 wherein the pinion and rack are constructed from one of stainless steel, bronze or aluminum.

8. The modular valve actuator of claim 1 wherein the rack is positioned between a first piston and a second piston with the first piston on a right side of the rack and the second piston on a left side of the rack.

9. The modular valve actuator of claim 8, wherein the first and second pistons are floating pistons.

10. The modular valve actuator of claim 1, further comprising a stem extension configured to be attached to the valve stem.

11. The modular valve actuator of claim 10, further comprising a handle spacer configured to be installed over the stem extension.

12. The modular valve actuator of claim 11, further comprising a handle configured to be attached to the stem extension to provide manual override capability to the valve.

13. A method of attaching a modular valve actuator to a valve, the method comprising:
removing a handle of the valve from a valve stem;
guiding the modular valve actuator over the valve stem wherein the valve stem is bounded within an opening defined by a pinion of the modular valve actuator; and
securing the modular valve actuator to the valve with bolts.

14. The method of claim 13, further comprising attaching a stem extension to the valve stem.

15. The method of claim 14, further comprising installing a handle spacer over the stem extension.

16. The method of claim 15, further comprising attaching a handle to the stem extension.

17. The method of claim 13, further comprising a sensor of the modular valve actuator detecting a target and generating positional data related to an open or closed position of the valve.

18. The method of claim 17, further comprising transmitting, by the sensor, the positional data to a connector of the modular valve actuator.

19. The method of claim 18, further comprising providing, by the connector, the positional data to a device attached to the connector.

20. A modular valve actuator comprising:
a housing;
a pinion constructed from metal, the pinion defining an opening and including pinion teeth; and
a rack constructed from metal, the rack includes rack teeth and a position target, wherein the pinion teeth interlock and interact with the rack teeth and the position target is a magnet;
a first piston on a right side of the rack and a second piston on a left side of the rack; and
a sensor, wherein the modular valve actuator is configured to be installed directly to a valve by guiding the modular valve actuator over a valve stem of the valve, wherein the valve stem is bounded within the opening defined by the pinion of the modular valve actuator, and the sensor is a non-contact sensor which detects the position target in the rack and generates positional data related to an open or closed position of the valve.
